(19) United States
(12) Patent Application Publication
(10) Pub. No.: US 2012/0308915 A1
(43) Pub. Date: Dec. 6, 2012

(54) CATHODE MATERIAL FOR FUEL CELL, CATHODE INCLUDING THE CATHODE MATERIAL, SOLID OXIDE FUEL CELL INCLUDING THE CATHODE

(75) Inventors: Hee-jung PARK, Suwon-si (KR); Soo-yeon SEO, Seoul (KR); Kyoung-seok MOON, Hwaseong-si (KR); Huangang SHI, Nanjing (CN); Dengjie CHEN, Nanjing (CN); Zongping SHAO, Nanjing (CN)

(73) Assignees: SAMSUNG ELECTRO-MECHANICS CO., LTD., Suwon-si (KR); SAMSUNG ELECTRONICS CO., LTD., Suwon-si (KR)

(21) Appl. No.: 13/477,408

(22) Filed: May 22, 2012

(30) Foreign Application Priority Data
May 31, 2011 (KR) 10-2011-0052398
Sep. 28, 2011 (KR) 10-2011-0098613

(51) Int. Cl. H01B 1/08; H01M 8/10

(52) U.S. Cl. 429/496; 429/495; 252/518.1; 252/521.2; 252/521.1

(57) ABSTRACT

A cathode material for a fuel cell, the cathode material including a first metal oxide having a perovskite structure; and a second metal oxide having a spinel structure.

### CROSS-REFERENCE TO RELATED APPLICATIONS

This application claims priority to Korean Patent Application Nos. 10-2011-0052398, filed on May 31, 2011 and No. 10-2011-0098613, filed on Sep. 28, 2011, and all the benefits accruing therefrom under 35 U.S.C. §119, the contents of which in their entirety are herein incorporated by reference.

### BACKGROUND

1. Field

The present disclosure relates to a cathode material for a fuel cell, a cathode for a fuel cell that includes the cathode material, a method of manufacturing the cathode, and a solid oxide fuel cell (“SOFC”) employing the cathode material.

2. Description of the Related Art

Solid oxide fuel cells (“SOFC”s), are a high-efficiency environmentally friendly power generation technology and can directly convert the chemical energy of fuel gas into electrical energy. SOFCs use an ion-conductive solid oxide electrolyte. SOFCs have many advantages such as use of low-priced materials relative to other types of fuel cells, a relatively high permissible level for gas impurities, hybrid power generation capability, and high efficiency. Furthermore, the direct use of a hydrocarbon-based fuel without reforming to hydrogen may lead to a simplified fuel cell system and cost reduction. A SOFC includes an anode where oxidation of the fuel, such as hydrogen or the hydrocarbon, takes place, a cathode where reduction of oxygen gas to oxygen ions (O²⁻) occurs, and an ion conductive solid oxide electrolyte which conducts the oxygen ions (O²⁻).

Existing SOFCs use high-temperature durable materials such as high-temperature alloys or costly ceramic materials because they operate at a temperature as high as of 800˜1,000° C. The high-temperature operation results in a long time for initial system operation, and can result in impaired durability of materials impeding long-term system operation. Accomodation of the high operating temperature results in an overall cost increase, which has been a significant obstacle to commercialization.

For these reasons, a great deal of research has been conducted into lowering the operating temperature of SOFCs to 800° C. or less. However, a reduced SOFC operation temperature may lead to an abrupt cathode material electrical resistance increase, which reduces the output power density of the SOFC. As described above, the operating temperature of SOFCs has a significant impact on a resistance of the cathode. Thus it would be desirable to provide a cathode which can provided improved resistance for use in a medium-low temperature SOFC.

### SUMMARY

Provided is a cathode material for a fuel cell that results in a reduced polarization resistance of a cathode.

Provided is a cathode for a fuel cell that includes the cathode material.

Provided is a method of manufacturing the cathode for a fuel cell.

Provided is a solid oxide fuel cell (“SOFC”) employing the cathode for a fuel cell.

Additional aspects will be set forth in part in the description which follows and, in part, will be apparent from the description.

According to an aspect of the present disclosure, a cathode material for a fuel cell includes: a first metal oxide having a perovskite structure; and a second metal oxide having a spinel structure.

The first metal oxide may be represented by Formula 1 below:

AMO_{3±δ} Formula 1

wherein A is at least one element selected from a lanthanide element and an alkaline earth metal element; M is at least one transition metal element; and δ indicates an excess or deficit of oxygen.

The first metal oxide may be represented by Formula 2 below:

A^{′}₁₋ₓA″ₓM^{′O}_{3±δ} Formula 2

wherein A′ is at least one selected from barium (Ba), lanthanum (La), and samarium (Sm); A″ is different from A′ and A″ is at least one element selected from strontium (Sr), calcium (Ca), and barium (Ba); M′ is at least one element selected from manganese (Mn), iron (Fe), cobalt (Co), nickel (Ni), copper (Cu), titanium (Ti), niobium (Nb), chromium (Cr), and scandium (Sc); 0≦x<1; and δ indicates an excess or deficit of oxygen.

The first metal oxide may include at least one selected from barium strontium cobalt iron oxide (“BSCF”), lanthanum strontium cobalt oxide (“LSC”), lanthanum strontium cobalt iron oxide (“LSCF”), lanthanum strontium chromium manganese oxide (“LSCM”), lanthanum strontium manganese oxide (“LSM”), lanthanum strontium iron oxide (“LSF”), and samarium strontium cobalt oxide (“SSC”).

The second metal oxide may be represented by Formula 3 below:

M″₃O₄ Formula 3

wherein M″ is at least one of Co, Fe, Mn, V, Ti, Cr, or an alloy thereof.

The second metal oxide may be at least one selected from Co₃O₄, Fe₃O₄, and Mn₃O₄.

The second metal oxide may have a melting point of from about 800° C. to about 1,800° C., In some other embodiments, the second metal oxide may have a melting point of from about 900° C. to about 1,500° C.

The first metal oxide may be contained in an amount of about 60 wt % to about 99 wt %, and the second metal oxide may be contained in an amount of about 1 wt % to about 40 wt %, based on the total weight of the first metal oxide and the second metal oxide.

In some embodiments, the first metal oxide may be contained in an amount of about 70 wt % to about 95 wt %, and the second metal oxide may be contained in an amount of about 5 wt % to about 30 wt %, based on the total weight of the first metal oxide and the second metal oxide.

In some other embodiments, the first metal oxide may be contained in an amount of about 80 wt % to about 95 wt %, and the second metal oxide may be contained in an amount of about 5 wt % to about 20 wt %, based on the total weight of the first metal oxide and the second metal oxide.

The cathode material for a fuel cell may further include a third metal oxide having a fluorite structure.

In an embodiment, the third metal oxide may include cerium and at least one lanthanide element.

The third metal oxide may be represented by Formula 4 below:

Ce_{1-y}M′″_{y}O₂ Formula 4

wherein M′″ is at least one selected from lanthanum (La), praseodymium (Pr), neodymium (Nd), promethium (Pm), samarium (Sm), europium (Eu), gadolinium (Gd), terbium (Tb), dysprosium (Dy), and an alloy thereof; and 0<y<1.

The third metal oxide represented by Formula 4 may be doped with at least two lanthanide elements, each of which may have an average ionic diameter of about 0.90 to about 1.06.

In some embodiments, M′″ of Formula 4 may be co-doped with a heterogeneous material including Sm and at least one element selected from Pr, Nd, Pm, and an alloy thereof.

In some other embodiments a weight ratio of a combination of the first metal oxide and the second metal oxide to the third metal oxide may be about 99:1 to about 60:40.

In an embodiment, the weight ratio of the combination of the first metal oxide and the second metal oxide to the third metal oxide may be about 90:10 to about 70:30.

In other embodiment, the weight ratio of the combination of the first metal oxide and the second metal oxide to the third metal oxide may be from about 85:15 to about 75:25

According to another aspect of the present disclosure, a cathode for a fuel cell includes the cathode material described above.

According to another aspect of the present disclosure, a method of manufacturing a cathode for a fuel cell includes: providing a solution containing the above-described cathode material; coating the solution on a substrate to provide a coated substrate; and thermally treating the coated substrate to manufacture the cathode.

The thermally treating may be performed at a temperature of about 700° C. to less than about 1,000° C.

In some other embodiments the thermally treating may be performed at a temperature of about 800° C. to about 900° C.

According to another aspect of the present disclosure, a solid oxide fuel cell includes: a cathode including the above-described cathode material; an anode disposed opposite to the cathode; and a solid oxide electrolyte disposed between the cathode and the anode.

The solid oxide electrolyte may include at least one selected from a zirconia solid electrolyte, a ceria solid electrolyte, and a lanthanum gallate solid electrolyte.

The solid oxide electrolyte may include at least one selected from a zirconia including at least one selected from yttrium (Y) and scandium (Sc); an undoped zirconia; a ceria including at least one selected from gadolinium (Gd), samarium (Sm), lanthanum (La), ytterbium (Yb), and neodymium (Nd); an undoped ceria; a lanthanum gallate including at least one selected from strontium (Sr) and magnesium (Mg); and an undoped lanthanum gallate.

The solid oxide fuel cell may further include an electric current collector layer on an outer side of the cathode, the electric current collector layer may include at least one selected from lanthanum cobalt oxide (LaCoO₃), lanthanum strontium cobalt oxide (“LSC”), lanthanum strontium cobalt iron oxide (“LSCF”), lanthanum strontium manganese oxide (“LSM”), and lanthanum strontium iron oxide (“LSF”).

The solid oxide fuel cell may further include a functional layer effective to prevent or suppress a reaction between the cathode and the solid oxide electrolyte, the functional layer may include at least one selected from gadolinia-doped ceria (“GDC”), samaria-doped ceria (“SDC”), and yttria-doped ceria (“YDC”).

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic cross-sectional view of an embodiment of a structure of a solid oxide fuel cell (“SOFC”);

FIG. 2 is a graph of relative intensity (arbitrary units) versus scattering angle (degrees two-theta, 20) illustrating X-ray diffraction patterns of cathode materials of Manufacture Examples 1-5, Ba_{0.5}Sr_{0.5}Co_{0.8}Fe_{0.2}O₃ (“BSCF”), and Co₃O₄;

FIG. 3 is a graph of electrical conductivity, σ (Siemens per centimeter, Scm⁻¹) versus temperature (° C.) of the cathode materials of Manufacture Examples 1-5, Ba_{0.5}Sr_{0.5}Co_{0.8}Fe_{0.2}O₃ (“BSCF”), and Co₃O₄;

FIG. 4 is a graph of voltage (Volts) and power density (milliwatts per square centimeter, mWcm⁻²) versus current density (milliamperes per square centimeter, mAcm⁻²) illustrating the results of I-V measurements performed on a cell of Example 1;

FIG. 5 is a graph of voltage (Volts) and power density (milliwatts per square centimeter, mWcm⁻²) versus current density (mAcm⁻²) illustrating the results of I-V measurements performed on a cell of Comparative Example 1;

FIG. 6 is a graph of voltage (Volts) and power density (milliwatts per square centimeter, mWcm⁻²) versus current density (mAcm⁻²) illustrating the results of I-V measurements performed on a cell of Example 2;

FIG. 7 is a graph of voltage (Volts) and power density (milliwatts per square centimeter, mWcm⁻²) versus current density (mAcm⁻²) illustrating the results of I-V measurements performed on a cell of Comparative Example 2;

FIG. 8 is a graph of voltage (Volts) and power density (milliwatts per square centimeter, mWcm⁻²) versus current density (mAcm⁻²) illustrating the results of I-V measurements performed on a cell of Example 3;

FIG. 9 is a graph of voltage (Volts) and power density (milliwatts per square centimeter, mWcm⁻²) versus current density (mAcm⁻²) illustrating the results of I-V measurements performed on a cell of Comparative Example 3;

FIG. 10 is a graph of voltage (Volts) and power density (milliwatts per square centimeter, mWcm⁻²) versus current density (mAcm⁻²) illustrating the results of I-V measurements performed on a cell of Example 4;

FIG. 11 is a graph of voltage (Volts) and power density (milliwatts per square centimeter, mWcm⁻²) versus current density (mAcm⁻²) illustrating the results of I-V measurements performed on a cell of Example 5;

FIG. 12 is a graph of imaginary resistance (Z₂, ohms·cm²) versus real resistance (Z₁, ohms·cm²) illustrating the results of impedance measurements performed on the symmetrical cells of Example 6 and Comparative Example 4;

FIG. 13 is a graph of imaginary resistance (Z₂, ohms·cm²) versus real resistance (Z₁, ohms·cm²) illustrating the results of impedance measurements on symmetrical cells of Examples 7-8 and Comparative Example 5; and

FIG. 14 is a graph of log resistance, Log Rₚ (ohm·cm²) versus inverse temperature, 1/T (1/Kelvin, 1/K) illustrating the results of measuring cathode specific resistance (Rₚ) of the symmetrical cells of Examples 7-8 and Comparative Example 4 at different operating temperatures.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

According to an aspect of the present disclosure, there is provided a cathode material for a fuel cell that includes a first metal oxide having a perovskite structure and a second metal oxide having a spinel structure. In an embodiment, the cathode material for a fuel cell may further include a third metal oxide having a fluorite structure.

Electrochemical reactions in solid oxide fuel cells (“SOFC”s) include a cathode reaction, in which oxygen gas (O₂) supplied to an air electrode (e.g., a cathode) is reduced to provide oxygen ions (O²⁻), and an anode reaction, in which a fuel (e.g., H₂ or a hydrocarbon) supplied to a fuel electrode (e.g., an anode) reacts with the O²⁻ that has migrated through an electrolyte membrane. The electrochemical reactions are represented in the following Reaction Scheme:

### Reaction Scheme

Cathode: ½O₂+2e⁻→O²⁻

Anode: H₂+O²⁻→H₂O+2e⁻

In the cathode (e.g., air electrode) of a SOFC, oxygen adsorbed onto the electrode surface undergoes dissociation and surface diffusion, migrates to a triple phase boundary area where the electrolyte, the air electrode, and pores contact each other, and oxygen is reduced into oxygen ions by accepting electrons. The oxygen ions migrate to the fuel electrode through the electrolyte. Accordingly, an electrode reaction rate may be increased by enlarging the area of the triple phase boundary where the anode reaction takes place. According to an embodiment of the present disclosure, a cathode material for a fuel cell includes a first metal oxide having a perovskite structure and a second metal oxide having a spinel structure, and optionally further a third metal oxide having a fluorite structure, which increases the triple phase boundary area where the cathode reaction takes place, and thus electrode activity at low temperatures is markedly increased, and thus there is a reduced polarization resistance of the cathode.

In one embodiment, the first metal oxide having a perovskite structure may be represented by Formula 1 below.

AMO_{3±δ} Formula 1

In Formula 1, A is at least one element selected from a lanthanide element and an alkaline earth metal elements;

M is at least one of a transition metal element; and

δ indicates an excess or deficit of oxygen.

δ may be selected so that the perovskite metal oxide is electrically neutral, and defines an excess or deficit of oxygen. In some embodiments, δ may satisfy 0≦δ≦0.3, specifically 0.05≦δ≦0.25, more specifically 0.1≦δ≦0.2.

In an embodiment, the first metal oxide comprises a first element, a second element, and oxygen, wherein the first element is at least one element selected from a lanthanide element and an alkaline earth metal element, and wherein the second element is at least one transition metal element.

In another embodiment, the first metal oxide having a perovskite structure, which exhibits high electrode activity at low temperatures, may be a mixed ionic and electronic conductor (“MIEC”) having both ionic conductivity and electronic conductivity. Such MIECs are a single phase material with high electronic and ionic conductivities. Due to having a high oxygen diffusion coefficient and a high charge transfer coefficient (e.g., a high charge-exchange reaction rate constant), MIECs may provide reduction of oxygen on the entire electrode surface as well as at the triple phase boundary area, which results in high electrode activity at low temperatures, contributing to lowering the operating temperature of SOFCs. In an embodiment, as such a mixed conductor, the first metal oxide having a perovskite structure may be represented by Formula 2 below:

A^{′}₁₋ₓA″ₓM′O_{3±δ} Formula 2

In Formula 2 above, A′ is at least one element selected from barium (Ba), lanthanum (La), and samarium (Sm),

A″ is different from A′, and A″ is at least one element selected from strontium (Sr), calcium (Ca), and barium (Ba),

M′ is at least one element selected from manganese (Mn), iron (Fe), cobalt (Co), nickel (Ni), copper (Cu), titanium (Ti), niobium (Nb), chromium (Cr), and scandium (Sc),

0≦x<1, and

δ indicates an excess or deficit of oxygen. In an embodiment, A′ is barium, A″ is strontium, and M′ is cobalt and iron. In another embodiment, A′ is lanthanum, A″ is strontium, and M′ is cobalt and iron. As noted above, δ may be selected so that the perovskite metal oxide is electrically neutral. In some embodiments, δ may satisfy 0≦δ≦0.3, specifically 0.05≦δ≦0.25, more specifically 0.1≦δ≦0.2.

Non-limiting examples of the first metal oxide include barium strontium cobalt iron oxide (“BSCF”), lanthanum strontium cobalt oxide (“LSC”), lanthanum strontium cobalt iron oxide (“LSCF”), lanthanum strontium chromium manganese oxide (“LSCM”), lanthanum strontium manganese oxide (“LSM”), lanthanum strontium iron oxide (“LSF”), and samarium strontium cobalt oxide (“SSC”). In some embodiments, the first metal oxide may be Ba₁₋ₓSrₓCo_{1-y}Fe_{y}O₃ (wherein 0.1≦x≦0.5, and 0.05≦y≦0.5), La₁₋ₓSrₓFe_{1-y}Co_{y}O₃ (wherein 0.1≦x≦0.4, and 0.05≦y≦5), or Sm₁₋ₓSrₓCoO₃ (wherein 0.1≦x≦0.5). In some other embodiments, the first metal oxide may be an oxide such as Ba_{0.5}Sr_{0.5}Co_{0.8}Fe_{0.2}O₃, La_{0.6}Sr_{0.4}Co_{0.2}Fe_{0.8}O₃, or Sm_{0.5}Sr_{0.5}CoO₃. The first metal oxide may be used alone or in a combination thereof.

According to an embodiment of the present disclosure, the cathode material for a fuel cell includes a second metal oxide having a spinel structure along with the first metal oxide having a perovskite structure. The spinel structure is a crystalline structure of oxides, has the general composition XY₂O₄, and is normally ferromagnetic or ferromagnetic. In the spinel structure, the oxygen anions are arranged in a face-centered cubic close-packed lattice. There are two types of spinel structures: a normal spinel structure where the cations X²⁺ occupy tetrahedral sites in the lattice and the Y³⁺ cations occupy octahedral coordination sites in the lattice, and an inverse spinel structure where the Y³⁺ cations occupy the tetrahedral sites in the lattice and the X²⁺ and Y³⁺ cations each occupy half of the octahedral sites in the lattice. A unit cell can contain 8 XY₂O₄.

In another embodiment, the second metal oxide having a spinel structure may be represented by Formula 3 below.

M″₃O₄ Formula 3

In Formula 3 above, M″ is at least one selected from Co, Fe, Mn, V, Ti, Cr, and an alloy thereof.

The second metal oxide of Formula 3, and while not wanting to be bound by theory, is understood to be a mixed valence compound, and has a normal spinel structure wherein M²⁺ occupy the tetrahedral sites and M³⁺ occupy the octahedral sites. In some embodiments, the second metal oxide may be at least one selected from Co₃O₄, Fe₃O₄, and Mn₃O₄. An embodiment in which M″ is Co is specifically mentioned.

The second metal oxide having the spinel structure may ensure coating of the cathode at low temperatures when manufacturing a SOFC, discouraging formation of a non-conductive layer that may adversely affect performance, and may improve attachment (e.g., bond strength) between an electrolyte and a cathode material.

In forming a cathode of a SOFC, the thermal treatment temperature of a cathode material of a medium- or low-temperature perovskite-based oxide can be 1000° C. or greater. As a reaction byproduct from such a high-temperature thermal treatment of a perovskite-based cathode material and a zirconia-based electrolyte, a non-conductive phase, such as SrZrO₃, La₂Zr₂O₇, or the like, may be formed. These non-conductive phases exhibit low electrical conductivity and low electrode activity, and thus dramatically increase electrode resistance as well as electrolyte resistance. Therefore, to effectively or entirely prevent the formation of such a non-conductive phase, a ceria-based functional layer may be interposed between the perovskite-based cathode and the zirconia-based electrolyte. This may suppress a reaction between the cathode material and the electrolyte, and thus prevent or reduce an increase in resistance. However, a resistance increase from unwanted reactions between ceria and zirconia may be unavoidable, and mechanical problems such as a mismatch of thermal expansion coefficients may be caused. Ceria-based compounds used for the functional layer are known to be difficult to sinter, and thus densely coating such a ceria-based compound between the cathode and the electrolyte is considered disadvantageous in terms of costs and processing.

On the contrary, according to an embodiment of the present disclosure, the cathode material for a fuel cell includes the second metal oxide having a spinel structure in addition to the first metal oxide having a perovskite structure, and thus the thermal treatment temperature of the cathode material may be lowered to less than 1000° C. While not wanting to be bound by theory, use of a thermal treatment temperature less than 1000° C. may prevent or reduce a reaction between the cathode and the electrolyte, and thus may prevent or reduce formation of a non-conductive phase. Thus in an embodiment the cathode material for a fuel cell may be applied directly on the zirconia-based electrolyte without using an anti-reaction layer between the cathode and the electrolyte.

To lower the thermal treatment temperature, the second metal oxide having a spinel structure may be selected to have a low melting point. The second metal oxide may have a melting point of about 800° C. to about 1,800° C., and in some embodiments, may have a melting point of about 900° C. to about 1,500° C., specifically about 950° C. to about 1,450° C. . A second metal oxide having a melting point of greater than 800° C. is understood to provide desirable thermal treatment properties. The melting point of a material means a temperature at which it melts at a pressure of 1 atmosphere, i.e., the temperature at which liquid and solid phases coexist in equilibrium. A melting point may be measured from a phase change (solid-liquid equilibrium) or a heat change while the temperature of a material is changed at a pressure of 1 atmosphere.

In the cathode material for a fuel cell, the amount of the first metal oxide having a perovskite structure and the second metal oxide having a spinel structure may be determined in consideration of electrical conductivity, cathode resistance, power density, and the like. In some embodiments, the the first metal oxide may be contained in an amount of about 60 wt % to about 99 wt %, and the second metal oxide may be contained in an amount of about 1 wt % to about 40 wt %, based on a total weight of the first metal oxide and the second metal oxide. In some other embodiments, the first metal oxide may be contained in an amount of about 70 wt % to about 95 wt %, and the second metal oxide may be contained in an amount of about 5 wt % to about 30 wt %, based on a total weight of the first metal oxide and the second metal oxide. In some other embodiments, the first metal oxide may be contained in an amount of about 80 wt % to about 95 wt %, and the second metal oxide may be contained in an amount of about 5 wt % to about 20 wt %, based on a total weight of the first metal oxide and the second metal oxide.

In an embodiment, to increase ionic conductivity, the cathode material for a fuel cell may further include a third metal oxide having a fluorite structure, in addition to the first metal oxide and the second metal oxide. In an embodiment, the third metal oxide may be a ceria-based metal oxide doped with at least one lanthanide element.

In an embodiment, the third metal oxide may be represented by Formula 4 below.

Ce_{1-y}M′″_{y}O₂ Formula 4

wherein M′″ is at least one selected from lanthanum (La), praseodymium (Pr), neodymium (Nd), promethium (Pm), samarium (Sm), europium (Eu), gadolinium (Gd), terbium (Tb), dysprosium (Dy), and an alloy thereof; and 0<y<1.

The third metal oxide having a fluorite structure may have high ionic conductivity and low electrical conductivity. The high ionic conductivity of the third metal oxide may compensate for insufficient ionic conductivity of the perovskite material, and thus may lead to an increased reaction rate in the cathode. The third metal oxide may have a higher melting point (for example, >2000° C. for CeO₂) relative to the perovskite materials (for example, 1180° C. for BSCF), and thus may be conducive to improvement in durability.

In some embodiments, the third metal oxide represented by Formula 4 may be doped with at least two lanthanum-based heterogeneous elements (e.g., lanthanides), of which an average ionic diameter may be from about 0.90 to about 1.06, and in some other embodiments, may be from about 0.96 to about 0.98. When the average ionic diameter of the heterogeneous elements is within these ranges, an increased ionic conductivity may be attained. In an embodiment, the heterogeneous element M′″ doping ceria in the third metal oxide may be at least two heterogeneous lanthanide elements selected from, for example, Sm, Pr, Nd, Pm, and an alloy thereof. For example, the heterogeneous element M′″ may include Sm as a dopant and may include an additional dopant selected from Pr, Nd, Pm, and an alloy thereof.

The amount (e.g., the mole fraction y) of the heterogeneous element M′″ doping ceria in the third metal oxide of Formula 4 may be 0<y<1, and in some embodiments, may be 0<y≦0.5, and in some other embodiments, may be 0<y≦0.3. An embodiment in which M′″ is lanthanum and 0<y<0.5 is specifically mentioned.

In some other embodiments, in which the third metal oxide is present, a weight ratio of a combination of the first metal oxide and the second metal oxide to the third metal oxide may be about 99:1 to about 60:40. For example, the weight ratio of a combination of the first metal oxide and the second metal oxide to the third metal oxide may be from about 90:10 to about 70:30, and in other embodiments, may be from about 85:15 to about 75:25, and in another embodiment, may be about 80:20.

According to another aspect of the present disclosure, there is provided a cathode for a fuel cell including the cathode material. The cathode may be available for a SOFC.

According to another embodiment of the present disclosure, there is provided a method of manufacturing the cathode for a fuel cell. The method of manufacturing the cathode for a fuel cell may include: providing a solution comprising the above-described cathode material; coating the solution on a substrate to provide a coated substrate; and thermally treating a coated structure.

In another embodiment, to provide the above-described cathode material for a fuel cell, e.g., the first metal oxide having a perovskite structure and the second metal oxide having a spinel structure is mixed (e.g., contacted) with a solvent to prepare a slurry. Then, after the slurry is coated on a predetermined substrate, a thermal treatment is performed to manufacture the cathode for a fuel cell. The slurry may further contain a third metal oxide having a fluorite structure, in addition to the first metal oxide and the second metal oxide.

The substrate coated with the slurry may be a solid oxide electrolyte comprising at least one of a zirconia-based solid electrolyte, a ceria-based solid electrolyte, and a lanthanum gallate-based solid electrolyte. Examples of the substrate include solid oxide electrolytes each including at least one of a zirconia-based material comprising (e.g., doped with) at least one selected from yttrium (Y) and scandium (Sc); an undoped zirconia-based material; a ceria-based material comprising (e.g., doped with) at least one of gadolinium (Gd), samarium (Sm), lanthanum (La), ytterbium (Yb), and neodymium (Nd); an undoped ceria-based material; a lanthanum gallate-based material comprising (e.g., doped with) at least one of strontium (Sr) and magnesium (Mg); and an undoped lanthanum gallate-based material.

The slurry may be coated directly on a solid oxide electrolyte using any of a variety of coating methods such as screen printing, deep coating, or the like. Also, an additional functional layer, such as an anti-reaction layer, may be disposed between the electrolyte and an electrode to effectively prevent a reaction therebetween.

The substrate coated with the slurry solution is thermally treated, thereby forming a cathode layer. The thermal treatment may be performed at a temperature of about 700° C. or greater to less than 1,000° C. In some embodiments, the thermal treatment may be performed at a temperature of about 800° C. to about 900° C. When the thermal treatment temperature is within these ranges, a cathode layer with a reduced polarization resistance may be manufactured without undesirable changes in the electrical characteristics and microstructures of the first metal oxide having a perovskite structure and the second metal oxide having a spinel structure. At the operating temperature of a middle- or low-temperature SOFC, which can be 800° C. or less, the cathode manufactured at the foregoing thermal treatment temperature may be able to stably function as a mixed conductor during the operation of the SOFC. According to an embodiment, the thermal treatment is performed at a lower temperature than a commercially practiced thermal treatment of perovskite-based cathode materials. This reduced thermal treatment temperature reduces or prevents reaction between the cathode and the electrolyte, thus preventing or reducing formation of a non-conductive phase.

In some embodiments, a second cathode layer including a commercially available cathode material, and/or an electric current collector may be further formed on the cathode for a fuel cell.

According to another aspect of the present disclosure, there is provided a SOFC including a cathode including the cathode material for a fuel cell, an anode disposed opposite to the cathode, and a solid electrolyte disposed between the cathode and the anode.

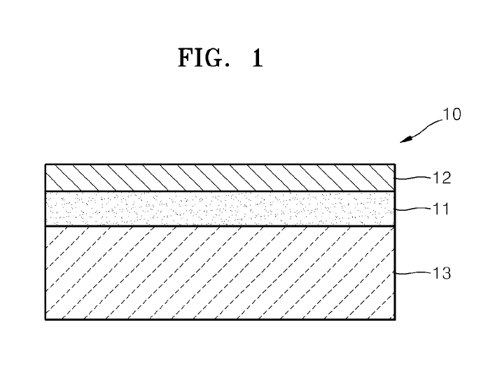

FIG. 1 is a schematic cross-sectional view of a structure of an embodiment of a SOFC 10. Referring to FIG. 1, the SOFC 10 includes a cathode 12 and an anode 13 disposed on opposite sides of a solid oxide electrolyte 11.

The solid oxide electrolyte 11 is desirably dense enough to prevent mixing of air and a fuel and provides a high oxygen ion conductivity and a low electron conductivity. Since the solid oxide electrolyte is disposed between the cathode 12 and the anode 13, a large difference in oxygen partial pressure may be present across the solid oxide electrolyte. Thus the solid oxide electrolyte 11 desirably maintains suitable physical properties in a wide range of oxygen partial pressures.

A material of the solid oxide electrolyte 11 is not specifically limited and may be any material used in the art. For example, the solid oxide electrolyte 11 may include at least one selected from of a zirconia-based solid electrolyte, a ceria-based solid electrolyte, and a lanthanum gallate-based solid electrolyte. For example, the solid oxide electrolyte 11 may include at least one selected from a zirconia-based material comprising (e.g., doped with) at least one of yttrium (Y) and scandium (Sc); an undoped zirconia-based material; a ceria-based material comprising (e.g., doped with) at least one of gadolinium (Gd), samarium (Sm), lanthanum (La), ytterbium (Yb), and neodymium (Nd); an undoped ceria-based material; a lanthanum gallate-based material comprising (e.g., doped with) at least one of strontium (Sr) and magnesium (Mg); and an undoped lanthanum gallate-based material. In some other embodiments, the solid oxide electrolyte 11 may be comprise a material selected from a stabilized zirconia-based material such as yttrium-stabilized zirconia (“YSZ”) and scandium-stabilized zirconia (“SSZ”); a rare earth element-comprising ceria-based material such as samarium-doped ceria (“SDC”) or gadolinium-doped ceria (“GDC”); and a ((La, Sr)(Ga, Mg)O₃)-based material (“LGSM”).

The solid oxide electrolyte 11 may have a thickness of about 10 nanometers (nm) to about 100 micrometers (μm), and in some embodiments, may have a thickness of about 100 nm to about 50 μm, specifically 0.5 μm to 25 μm.

The anode (e.g., fuel electrode) 13 is involved in electrochemical oxidation of a fuel and charge transfer. An anode catalyst is desirably chemically compatible with and has a similar thermal expansion coefficient as the electrolyte material. The anode 13 may include a cermet comprising the material forming the solid oxide electrolyte 11 and a nickel oxide. For example, when the solid oxide electrolyte 11 is formed of YSZ, a Ni/YSZ ceramic-metallic composite may be used for the anode 13. In addition, a Ru/YSZ cermet or a pure metal such as Ni, Co, Ru, Pt, or the like, may be used as a material for the anode 13, but the present disclosure is not limited thereto. The anode 13 may further include activated carbon if desired. The anode 13 may be sufficiently porous to facilitate diffusion of a fuel gas.

The anode 13 may have a thickness of about 1 μm to about 1,000 μm, and in some embodiments, may have a thickness of about 5 μm to about 100 μm, specifically about 10 μm to about 80 μm.

The cathode (e.g., air electrode) 12 may reduce oxygen gas into oxygen ions and may allow a continuous flow of air to maintain a constant partial oxygen pressure. The cathode 12 contains the cathode material for the fuel cell described above including the first metal oxide having the perovskite structure and the second metal oxide having the spinel structure. Since the cathode material for a fuel cell has already been described above, further detailed description thereof will not be repeated here.

The cathode 12 may have a thickness of from about 1 μm to about 100 μm, and in some embodiments, may have a thickness of about 5 μm to about 50 μm, specifically about 10 μm to about 40 μm.

The cathode 12 may be sufficiently porous to facilitate diffusion of oxygen gas. Thermally treated at a middle or low temperature during its formation, the cathode 12 is protected from reacting with the solid oxide electrolyte 11 to effectively or entirely prevent or suppress formation of a non-conductive layer between the cathode 12 and the solid oxide electrolyte 11. In some embodiments, a functional layer may be further included between the cathode 12 and the solid oxide electrolyte 11 if desired, to more effectively prevent a reaction between the two. The functional layer may include, for example, at least one selected from gadolinia-doped ceria (“GDC”), samaria-doped ceria (“SDC”), and yttria-doped ceria (“YDC”). The functional layer may have a thickness of from about 1 μm to about 50 μm, and in some embodiments, may have a thickness of about 2 μm to about 10 μm, specifically about 4 μm to about 8 μm.

In some embodiments the SOFC 10 may further include an electric current collector layer containing an electron conductor on at least one side of the cathode 12, for example, on an outer side of the cathode 12. The electric current collector layer may serve as a current collector of the cathode structure.

For example, the electric current collector layer may include at least one selected from lanthanum cobalt oxide (LaCoO₃), lanthanum strontium cobalt oxide (“LSC”), lanthanum strontium cobalt iron oxide (“LSCF”), lanthanum strontium manganese oxide (“LSM”), and lanthanum strontium iron oxide (“LSF”). The electric current collector layer may be formed using the materials described above alone or in a combination thereof. In some embodiments, a single-layered structure or a stacked structure of at least two layers may be formed using these materials.

The SOFC may be manufactured using any commercially available process disclosed in literature, the details of which can be selected by one of skill in the art without undue experimentation, and thus, a detailed description thereof will not be repeated herein. The SOFC may be applied to any of a variety of structures, for example, a tubular stack, a flat tubular stack, or a planar stack.

Hereinafter, one or more embodiments of the present disclosure will be further described in detail with reference to the following examples. These examples are not intended to limit the purpose and scope of the one or more embodiments of the present disclosure.

### PREPARATION EXAMPLE 1

### Preparation of Cathode Material (1)

Perovskite Ba_{0.5}Sr_{0.5}Co_{0.8}Fe_{0.2}O₃ powder was synthesized using an ethylenediaminetetraacetic acid (“EDTA”)-citric acid method. In particular, 3.5630 grams (g) of Ba(NO₃)₂, 2.8853 g of Sr(NO₃)₂, 6.3485 g of Co(NO₃)₃.6H₂O, 2.2031 g of Fe(NO₃)₃.9H₂O, 9.15 g of EDTA, and 6.10 g of citric acid were added to 150 milliliters (mL) of distilled water, and the combination was then agitated using a magnetic bar until the solids were completely dissolved. To remove the organic components, the resulting solution was maintained on a 250° C. with a hot plate for about 12 hours to provide a dry powder. The obtained dry powder was thermally treated at 900° C. for about 2 hours, thereby obtaining Ba_{0.5}Sr_{0.5}Co_{0.8}Fe_{0.2}O₃ (abbreviated to ‘BSCF’) powder having a perovskite structure.

A mixture of the obtained BSCF and a commercially available spinel-structured Co₃O₄ powder (m.p.=895° C., available from Sigma-Aldrich) were combined in the proportions 95 wt % and 5 wt %, respectively, based on the total amount of the BSCF and the Co₃O₄, and were then mixed together with zirconia balls in ethanol by ball milling. After completion of the ball milling, the mixture was dried in an oven to obtain a cathode material.

### PREPARATION EXAMPLE 2

### Preparation of Cathode Material (2)

A cathode material was prepared in the same manner as in Preparation Example 1, except that a combination of 90 wt % of BSCF and 10 wt % of Co₃O₄ was mixed.

### PREPARATION EXAMPLE 3

### Preparation of Cathode Material (3)

A cathode material was prepared in the same manner as in Preparation Example 1, except that a combination of 80 wt % of BSCF and 20 wt % of Co₃O₄ was mixed.

### PREPARATION EXAMPLE 4

### Preparation of Cathode Material (4)

A cathode material was prepared in the same manner as in Preparation Example 1, except that a combination of 70 wt % of BSCF and 30 wt % of Co₃O₄ was mixed.

### PREPARATION EXAMPLE 5

### Preparation of Cathode Material (5)

A cathode material was prepared in the same manner as in Preparation Example 1, except that a combination of 60 wt % of BSCF and 40 wt % of Co₃O₄ was mixed.

### PREPARATION EXAMPLE 6

### Preparation of Cathode Material (6)

A cathode material prepared using a mixture of 95 wt % of LSCF and 5 wt % of Co₃O₄ was prepared in the same manner as in Preparation Example 1, except that La_{0.8}Sr_{0.4}Co_{0.2}Fe_{0.8}O₃(hereinafter, abbreviated to ‘LSCF’) was used as a perovskite material instead of BSCF.

The LSCF was prepared using an EDTA-citric acid method like that used to prepare BSCF, except that 5.3704 g of La(NO₃)₃.6H₂O, 1.7490 g of Sr(NO₃)₂, 1.2026 g of Co(NO₃)₃.6H₂O, 6.6778 g of Fe(NO₃)₃.9H₂O, 9.24 g of EDTA, and 4.62 g of citric acid were added to 150 mL of distilled water, and were then completely dissolved to provide a solution, and the solution was used to synthesize LSCF powder.

### PREPARATION EXAMPLE 7

### Preparation of Cathode Material (7)

A cathode material prepared using a mixture of 95 wt % of SSC and 5 wt % of Co₃O₄ was prepared in the same manner as in Preparation Example 1, except that Sm_{0.5}Sr_{0.5}CoO₃ (abbreviated to ‘SSC’) was used as a perovskite material instead of BSCF.

The SSC was prepared using an EDTA-citric acid method like that used to prepare BSCF, except that 5.2963 g of La(NO₃)₃.6H₂O, 2.5873 g of Sr(NO₃)₂, 7.1163 g of Co(NO₃)₃.6H₂O, 9.62 g of EDTA, and 4.81 g of citric acid were added to 150 mL of distilled water, and were then completely dissolved to prepare a solution, and the solution used used to synthesize SSC powder.

### PREPARATION EXAMPLE 8

### Preparation of Cathode Material (8)

A cathode material prepared using a mixture of 95 wt % of BSCF and 5 wt % of Fe₃O₄ was prepared in the same manner as in Preparation Example 1, except that a commercially available spinel-structure Fe₃O₄ powder (m.p.=1538° C., available from Sigma-Aldrich) was used instead of Co₃O₄.

### PREPARATION EXAMPLE 9

### Preparation of Cathode Material (9)

A cathode material prepared using a mixture of 95 wt % of BSCF and 5 wt % of Mn₃O₄ was prepared in the same manner as in Preparation Example 1, except that a commercially available spinel-structure Mn₃O₄ powder (m.p.=1564° C., available from Sigma-Aldrich Co.) was used instead of Co₃O₄.

### PREPARATION EXAMPLE 10

### Preparation of Cathode Material (10)

Ce_{0.8}Sm_{0.15}Nd_{0.05}O₂ (“SNDC”) powder having a fluorite structure was synthesized by solid state reaction. In particular, 7.993 g of CeO₂, 1.518 g of Sm₂O₃, and 0.488 g of Nd₂O₃ were placed into a plastic vessel along with 100 mL of ethanol and commercially available zirconia balls and ball milled for about 12 hours. After the ball milling, the resulting product was maintained on a hot plate at about 80° C. for about 10 hours to obtain dry powder. The obtained dry powder was thermally treated at about 1200° C. for about 2 hours to obtain SNDC powder having a fluorite structure.

The BSCF having a perovskite structure of Preparation Example 1, the spinel-structured Co₃O₄ powder for commercial use (available from Sigma-Aldrich), and the fluorite-structured SNDC were combined in the proportions 72 wt %, 8 wt %, and 20wt %, respectively, based on the total weight of the BSCF, the Co₃O₄, and the SNDC, and then mixed together in ethanol by ball milling with zirconia balls. After completion of the mixing, the mixture was dried in an oven to obtain a cathode material. The above amounts of the materials were equivalent to 0.8 {(BSCF)0.9+(Co₃O₄)0.1}+0.2 SNDC.

### EVALUATION EXAMPLE 1

### XRD Pattern Measurement of Cathode Material

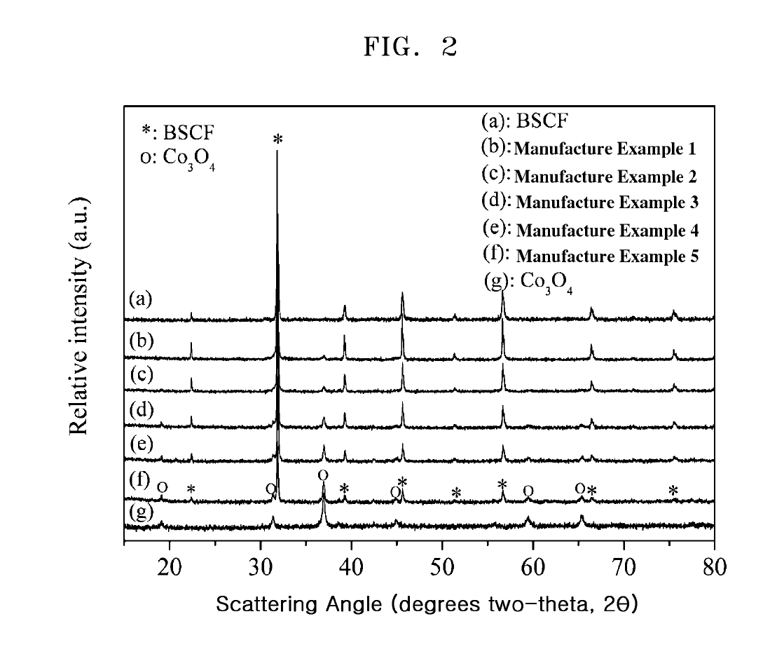

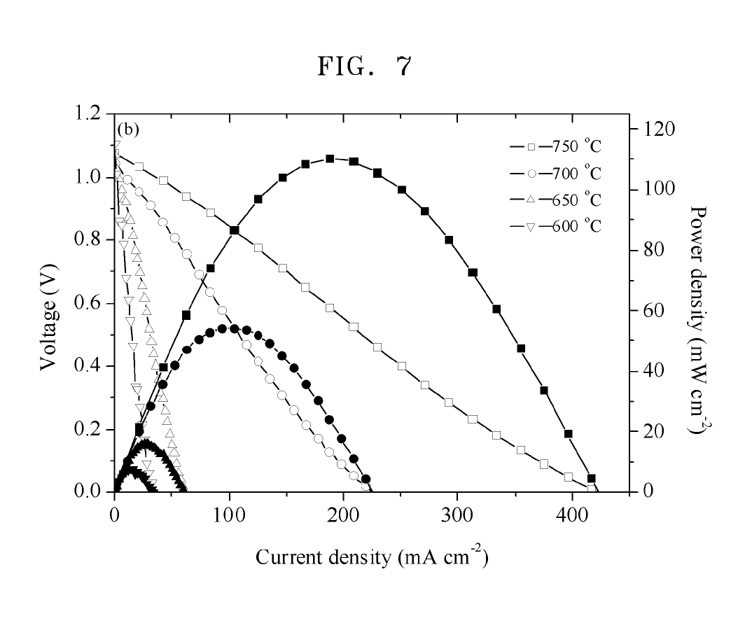

To investigate whether the perovskite material and spinel material reacted with each other, after being thermally treated at 1000° C., each cathode material of Preparation Examples 1 to 5 were analyzed by X-ray diffraction using CuKα rays. The results are shown in FIG. 2. For comparison with the X-ray diffraction patterns of the cathode materials of Preparation Examples 1 to 5, X-ray patterns of BSCF and Co₃O₄ used in Preparation Example 1 are also shown in FIG. 7.

As shown in FIG. 2, the cathode materials of Preparation Examples 1 to 5, in which the amounts of BSCF and Co₃O₄ were varied, are found to have a BSCF phase and Co₃O₄ phase remaining even after the thermal treatment at about 1000° C. Also, another phase is not present in the X-ray diffraction pattern. This indicates that the obtained cathode materials are in a physically mixed state.

### EVALUATION EXAMPLE 2

### Electrical Conductivity Measurement of Cathode Material

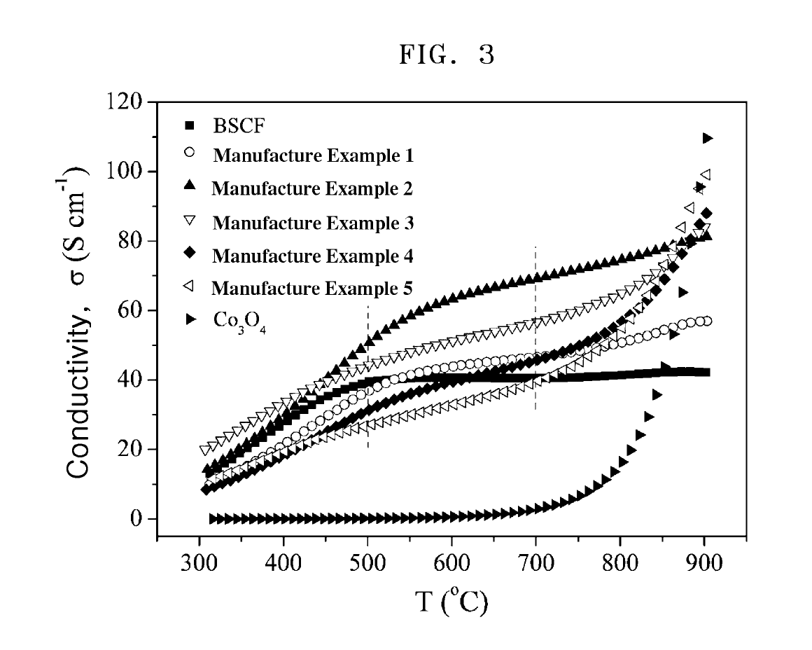

The electrical conductivity of the cathode materials of Preparation Examples 1 to 5 were analyzed using a 4-point probe direct current (“DC”) method. Each cathode material in powder form was molded into a bulk shape using a metal mold, and was then sintered to obtain a coin-shaped bulk structure, which was then cut into square bars using a diamond cutter. Dimensions of the individual square bars were 1.5 centimeters (cm) in width, 0.3 cm in length, and 0.3 cm in height. The electrical conductivities of each bulk structure were measured in air at a temperature of from about 300° C. to about 900° C. using a current-voltage source meter (K2400, available from Keithley). The results are shown in FIG. 3. For comparison with the electrical conductivities of the cathode materials of Preparation Examples 1 to 5, the electrical conductivities of BSCF and Co₃O₄ used in Preparation Example 1 are shown in FIG. 3.

Referring to FIG. 3, the cathode materials comprising a mixture of BSCF and Co₃O₄ are found to have a higher or similar electrical conductivity at a temperature range of 500° C. or higher, as compared with that of BSCF, which is a desirable SOFC operating temperature. Thus the cathode materials comprising a mixture of BSCF and Co₃O₄ may be suitable for a SOFC operating at a middle or low operating temperatures of 800° C. or less.

### EXAMPLE 1-5

### Manufacture of a Cell

A mixed composite material of NiO and YSZ (Zr_{0.84}Y_{0.16}O₂) was used as an anode support. A bulk structure was manufactured to have a cylindrical shape having a diameter of about 30 millimeters (mm) and a thickness of about 1 mm using die press.

YSZ was applied to the anode support using die pressing to have a thickness of about 20 micrometers (μm), and sintered at about 1400° C. to form a solid electrolyte (“SE”).

1 g of each cathode material of Preparation Examples 1 and 6-9 was mixed with 1 mL of commercially available FCM Ink vehicle (VEH, available from Fuel Cell Materials, Lewis Center, Ohio) to prepare a slurry, which was then coated on the SE using screen printing to a thickness of about 10 μm to form a cathode layer, followed by a thermal treatment at about 800° C. for about 2 hours, thereby completing the manufacture of a cell.

### COMPARATIVE EXAMPLES 1-3

### Manufacture of Cells for Comparison

For output density comparison with the cathode materials used in Examples 1 to 5, cells 1, 2, and 3 were manufactured in the same manner as in Examples 1 to 5, except that the BSCF (Ba_{0.5}Sr_{0.5}Co_{0.8}Fe_{0.2}O₃) of Preparation Example 1, the LSCF (La_{0.6}Sr_{0.4}Co_{0.2}Fe_{0.8}O₃) of Preparation Example 6, or the SSC (Sm_{0.5}Sr_{0.5}CoO₃) of Preparation Example 7 was used to form a cathode layer.

### EVALUATION EXAMPLE 3

### Measurement of Current-Voltage and Output Density

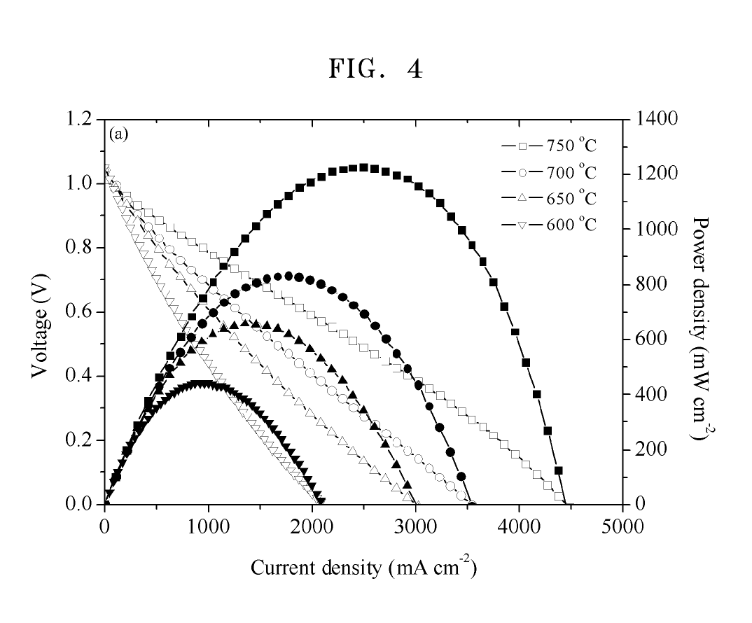

I-V and I-P characteristics (where I is current, V is voltage, and P is power density) were measured on the cells of Examples 1-5 and Comparative Examples 1-3. Oxygen was supplied to the air electrode (e.g., cathode) and hydrogen gas was applied to the fuel electrode (e.g., anode), and an open circuit voltage (“OCV”) of 1V or greater was obtained. To obtain I-V data, voltage drops were measured with a current increase from 0 Ampere (A) to several Amperes until the voltage reached 0V. I-P data were calculated from the I-V data. The resulting I-V and I-P data are shown in FIGS. 4 to 11. In FIGS. 4-11, open symbols are the I-V results at different temperatures, and the corresponding closed (i.e., filled) symbols are the results of the output density calculated from the I-V plots.

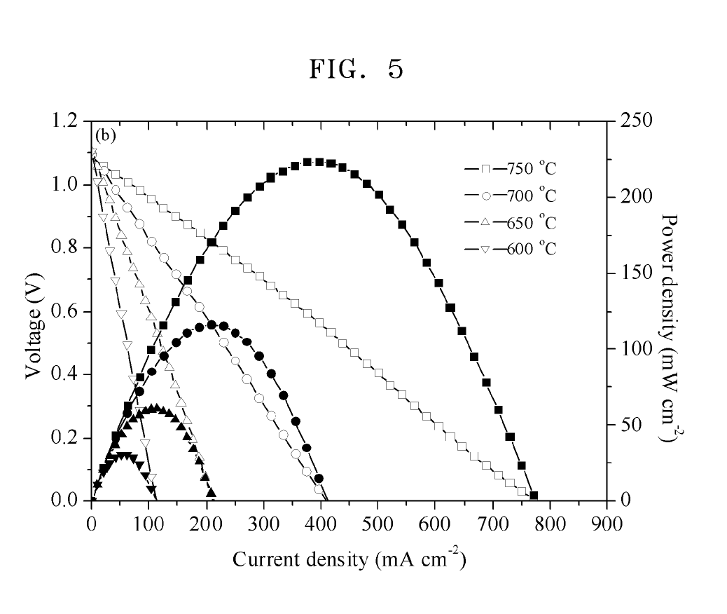

FIG. 4 is a graph showing the I-V characteristics of the cell of Example 1 including the mixed cathode material of BSCF and Co₃O₄. FIG. 5 is a graph showing the I-V characteristics of the cell of Comparative Example 1 including only BSCF as its cathode material without Co₃O₄. Referring to FIG. 4, the cell of Example 1 with the cathode layer of the BSCF (95 wt %) and Co₃O₄ (5 wt %) mixture coated on the cathode support zirconia SE is found to have high performance. The cell of Example 1 had a maximum output density of about 1.2 W/cm² at about 750° C., and a maximum output density of about 0.8 W/cm² at about 700° C. These output density levels are far higher as compared with known zirconia electrolyte cells. In the cell of Comparative Example 1 using only BSCF as its cathode material without Co₃O₄, a reaction between the BSCF and the zirconia SE is understood to have resulted in considerable performance deterioration.

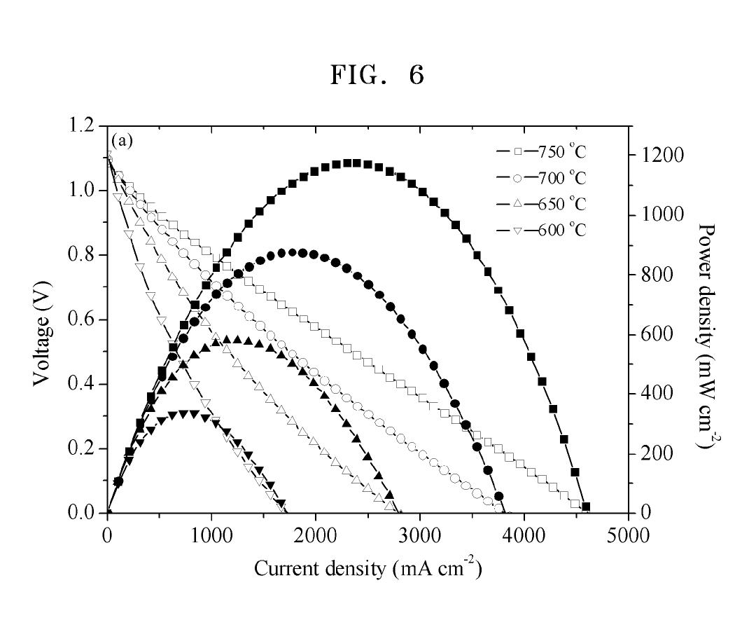

FIG. 6 is a graph showing the I-V characteristics of the cell of Example 2 including the mixed cathode material of the perovskite material LSCF and Co₃O₄. FIG. 7 is a graph showing the I-V characteristics of the cell of Comparative Example 2 including only LSCF as its cathode material without Co₃O₄. Referring to FIGS. 6 and 7, the cell of Example 2 with the cathode layer of the LSCF and Co₃O₄ mixture is found to have better performance as compared with the cell using LSCF alone.

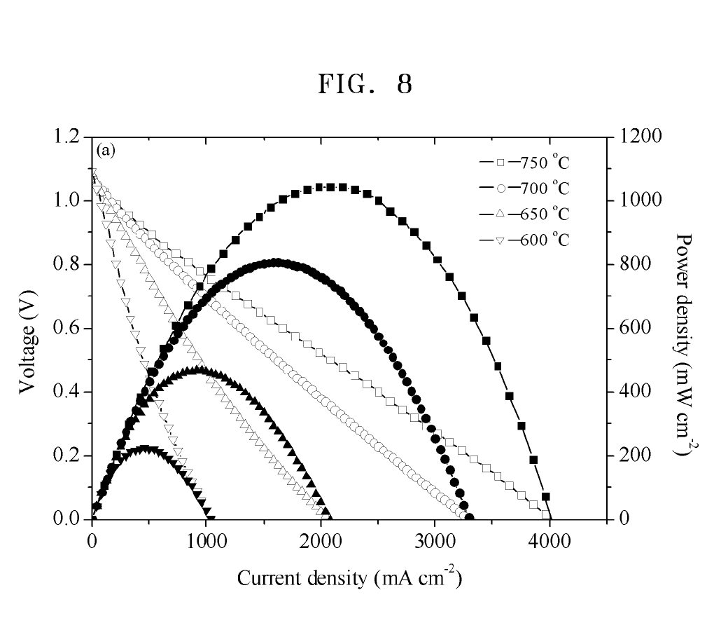

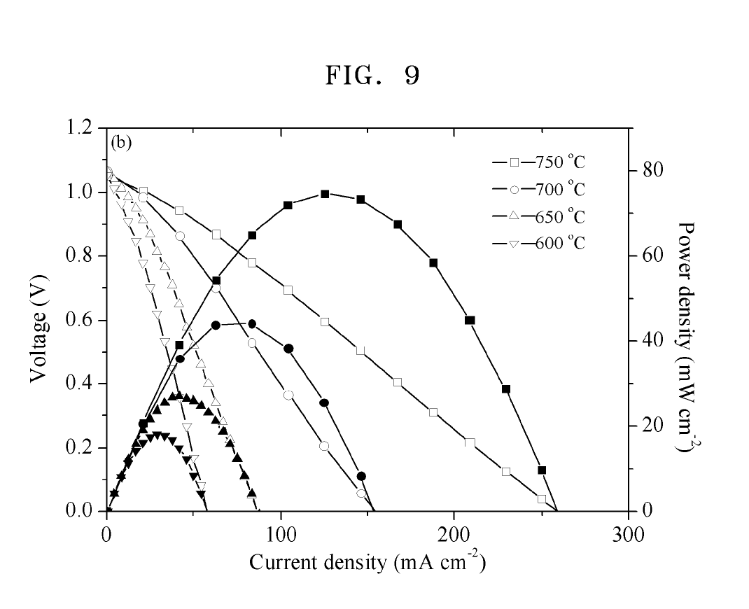

FIG. 8 is a graph showing the I-V characteristics of the cell of Example 3 including the mixed cathode material of the perovskite material SSC and Co₃O₄. FIG. 9 is a graph showing the I-V characteristics of the cell of Comparative Example 3 including only SSC as its cathode material without Co₃O₄. Referring to FIGS. 8 and 9, the cell of Example 3 with the cathode layer of the SSC and Co₃O₄ mixture is found to have better performance as compared with the cell using SSC alone.

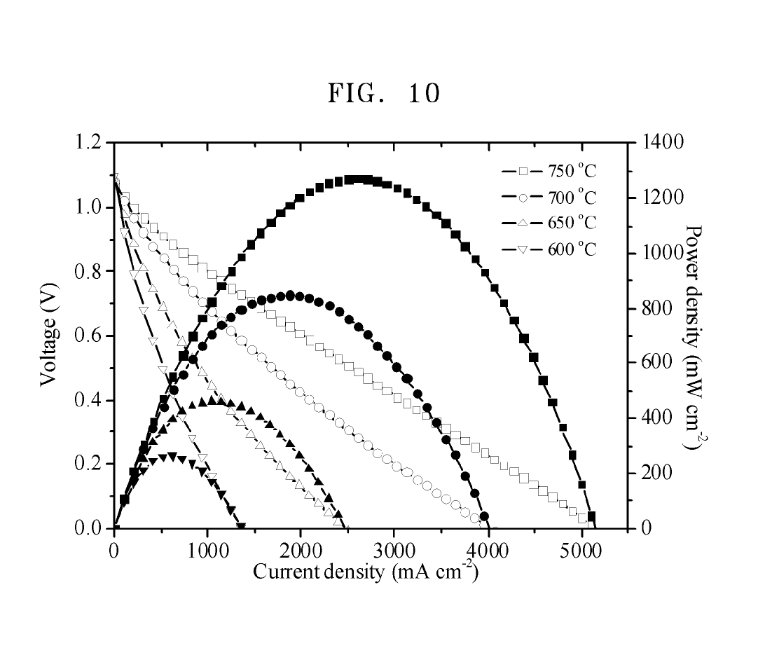

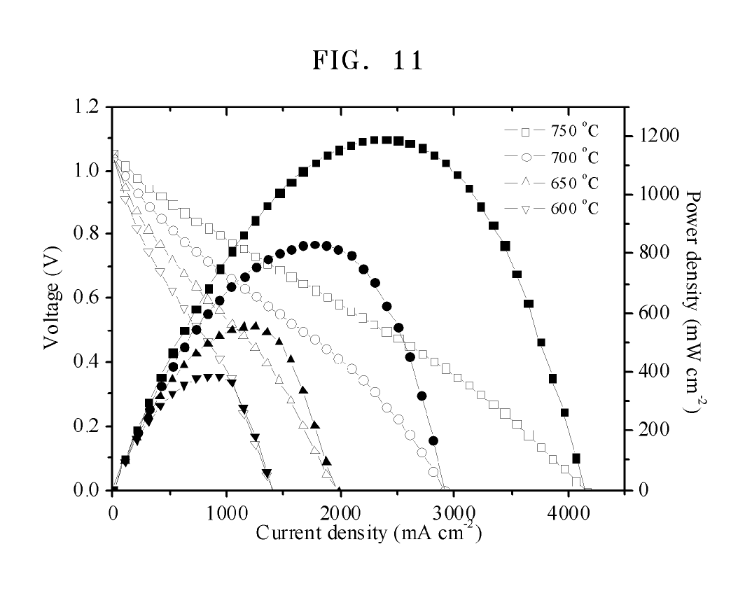

FIG. 10 is a graph showing the I-V characteristics of the cell of Example 4 including the mixed cathode material of LSCF and the spinel material Co₃O₄. FIG. 11 is a graph showing the I-V characteristics of the cell of Example 5 including only BSCF as its cathode material without Mn₃O₄. Referring to FIGS. 10 and 11, like the cell including Co₃O₄, the cells including Fe₃O₄ or Mn₃O₄ along with a perovskite material are found to have improved performance.

The cell performances (i.e., peak power density) of the cells of Examples 1-5 and Comparative Examples 1-3 are summarized in Table 1 below.

TABLE 1

| | | | Cell Performance | | |
|---|---|---|---|---|---|
| | | | (peak power density, | | |
| | | | mW/cm²) | | |
| | Relevant | Cathode | 600° | 650° | 700° |
| | Drawing | Composition | C. | C. | C. |
| Example 1 | FIG. 4 | BSCF (95 wt %) + | 440 | 1458 | 1770 |
| | | Co₃O₄ (5 wt %) | | | |
| Comparative | FIG. 5 | BSCF | 30 | 60 | 116 |
| Example 1 | | | | | |
| Example 2 | FIG. 6 | LSCF (95 wt %) + | 336 | 581 | 876 |
| | | Co₃O₄ (5 wt %) | | | |
| Comparative | FIG. 7 | LSCF | 7 | 15 | 54 |
| Example 2 | | | | | |
| Example 3 | FIG. 8 | SSC (95 wt %) + | 222 | 465 | 805 |
| | | Co₃O₄ (5 wt %) | | | |
| Comparative | FIG. 9 | SSC | 18 | 27 | 44 |
| Example 3 | | | | | |
| Example 4 | FIG. 10 | BSCF (95 wt %) + | 263 | 460 | 849 |
| | | Fe₃O₄ (5 wt %) | | | |
| Example 5 | FIG. 11 | BSCF (95 wt %) + | 387 | 552 | 832 |
| | | Mn₃O₄ (5 wt %) | | | |

### EXAMPLE 6

### Manufacture of Symmetrical Cell (1)

To investigate the effects of spinel structure Co₃O₄ and rock salt structure CoO on cathode performance, a symmetrical cell was manufactured having a pair of cathode layers coated on opposite sides of an electrolyte membrane.

The electrolyte membrane of the symmetrical cell was formed using commercially available YSZ powder (TZ-8Y, available from Tosoh, Tokyo, Japan). In particular, YSZ powder was molded in a metal mold by die pressing, and was then compressed by cold isostatic pressing (“CIP”) with an application of 200 megapascals MPa of pressure. The resulting product was sintered at about 1550° C. to obtain a coin-shaped bulk molded structure, about 1 mm-thick.

To form the cathode layers on the opposite sides of the electrolyte membrane, commercially available LSCF powder (La_{0.8}Sr_{0.4}Co_{0.2}Fe_{0.8}O₃, available from Fuel Cell Materials Co., Ltd.) and 5 wt % of the commercially available Co₃O₄ powder were mixed with a commercially available FCM Ink vehicle (VEH, available from Fuel Cell Materials, Lewis Center, Ohio) using a mortar to prepare a slurry, which was then coated on the opposite sides of the YSZ electrolyte membrane using screen printing to a thickness of about 10 μm. After the coating, the coating was thermally treated at about 800° C. to bind the cathode layers and the electrolyte membrane, thereby completing the manufacture of the symmetrical cell.

### COMPARATIVE EXAMPLE 4

### Manufacture of Symmetrical Cell for Comparison (1)

A symmetrical cell for comparison was manufactured in the same manner as in Example 6, except that commercially available CoO powder (available from Sigma-Aldrich) having a rock salt structure was added instead of the spinel structure Co₃O₄.

### EVALUATION EXAMPLE 4

### Impedance Measurement

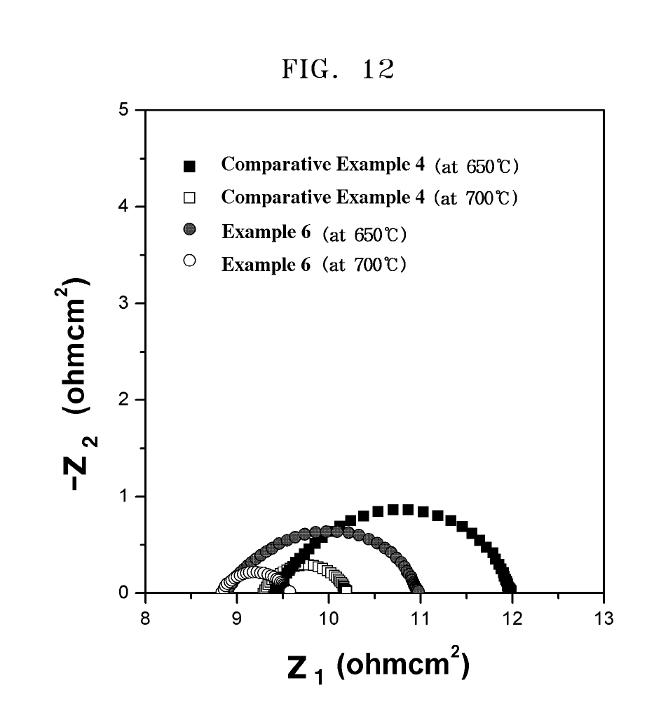

The impedance of the symmetrical cells of Examples 6 and Comparative Example 4 were measured in an air atmosphere. The results are shown in FIG. 12. The device used in the impedance analysis was a Materials Mates 7260 impedance meter (available from Materials Mates). The operating temperatures of the cells were 650° C. and 700° C.

In FIG. 12, the size (diameter) of semicircles indicates a level of cathode resistance (R_{ca}). Referring to FIG. 12, the symmetrical cell of Example 6 using the mixed cathode material of LSCF and Co₃O₄ has a smaller semicircle as compared with the symmetrical cell of Comparative Example 4 using the mixed cathode material of LSCF and CoO. The cathode resistance at 700° C. was about 0.7 ohm·cm² in the symmetrical cell of Example 6, and about 0.9 ohm·cm² in the symmetrical cell of Comparative Example 4. The cathode resistance at 650° C. was about 2.0 ohm·cm² in the symmetrical cell of Comparative Example 6, and was about 2.6 ohm·cm² in the symmetrical cell of Comparative Example 4. The results are summarized in Table 2 below. FIG. 12 and Table 1 show that Co₃O₄ having a spinel structure is an effective additive which improves cathode performance.

TABLE 2

| | Cathode Resistance at | Cathode Resistance at |
|---|---|---|
| | 700° C. (ohm · cm²) | 650° C. (ohm · cm²) |
| Example 6 | 0.7 | 2.0 |
| Comparative Example 4 | 0.9 | 2.6 |

### EXAMPLES 7-8

### Manufacture of Symmetrical Cells (2)

To investigate the effects of adding the spinel-structured Co₃O₄ and the fluorite-structured SNDC to the perovskite-structured BSCF on electrode resistance, symmetrical cells was manufactured, each having a pair of cathode layers coated on opposite sides of an electrolyte membrane. The electrolyte membrane of each symmetrical cell was formed using commercially available YSZ powder (TZ-8Y, available from Tosoh). In particular, YSZ powder was molded in a metal mold by die pressing, and was then compressed by cold isostatic pressing (“CIP”) with an application of 200 MPA. The resulting product was sintered at about 1550° C. to obtain a coin-shaped, about 1 mm-thick, bulk molded structure. To the cathode layers on the opposite sides of each electrolyte membrane, commercially available GDC powder (available from Fuel Cell Materials Co., Ltd.) were coated on opposite sides of the bulk molded structure by screen printing, and then slurries prepared by mixing the cathode materials BSCF and Co₃O₄ (of Preparation Example 2) and BSCF, Co₃O₄ and SNDC (of Preparation Example 10) respectively in a commercially available FCM Ink vehicle (VEH, available from Fuel Cell Materials, Lewis Center, Ohio) using a mortar were then each coated on the coated opposite sides of the bulk molded structure by screen printing to form the cathode layers having a thickness of about 10 μm. After the coating, the structure including BSCF and Co₃O₄ and the structure including BSCF, Co₃O₄, and SNDC were thermally treated at about 800° C. and about 900° C., respectively, thereby completing the manufacture of the symmetrical cells.

### COMPARATIVE EXAMPLE 5

### Manufacture of Symmetrical Cell (2)

A symmetrical cell for comparison was manufactured in the same manner as in Example 7, except that only BSCF was used as the cathode material.

### EVALUATION EXAMPLE 5

### Impedance Measurement

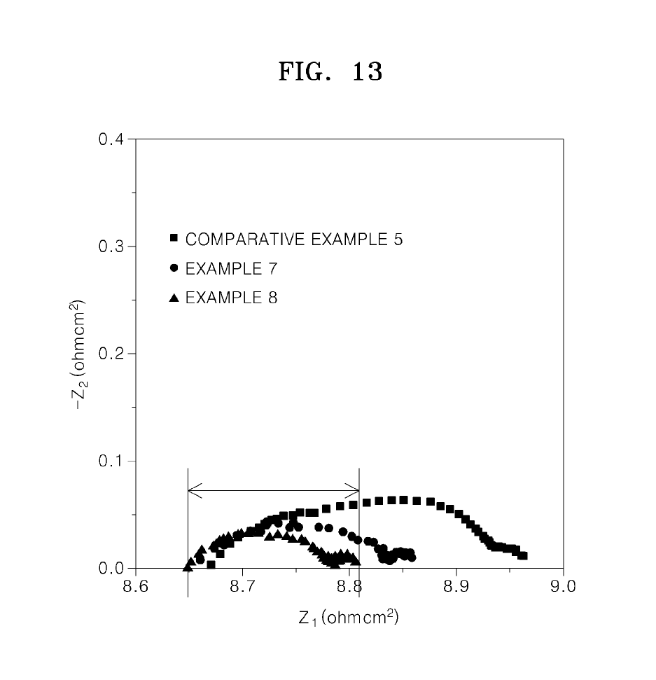

The impedance of the symmetrical cells of Examples 7-8 and Comparative Example 5 were measured in an air atmosphere. The results are shown in FIG. 13.

In FIG. 13, the size (diameter) of the semicircles relates to a level of cathode resistance (R_{ca}), as in FIG. 12. Referring to FIG. 13, the size of semicircles is found to be smaller in the symmetrical cell of Example 7 using the mixed cathode materials BSCF and Co₃O₄ as compared with that using the cathode material BSCF alone of Comparative Example 5, and is smallest in the symmetrical cell of Example 8 which further includes SNDC in addition to BSCF and Co₃O₄. FIG. 13 shows that the fluorite-structured ionic conductor SNDC is an effective additive along with the spinel-structured material (Co₃O₄) to improve cathode performance.

### EVALUATION EXAMPLE 6

### Measurement of Cathode Specific Resistance

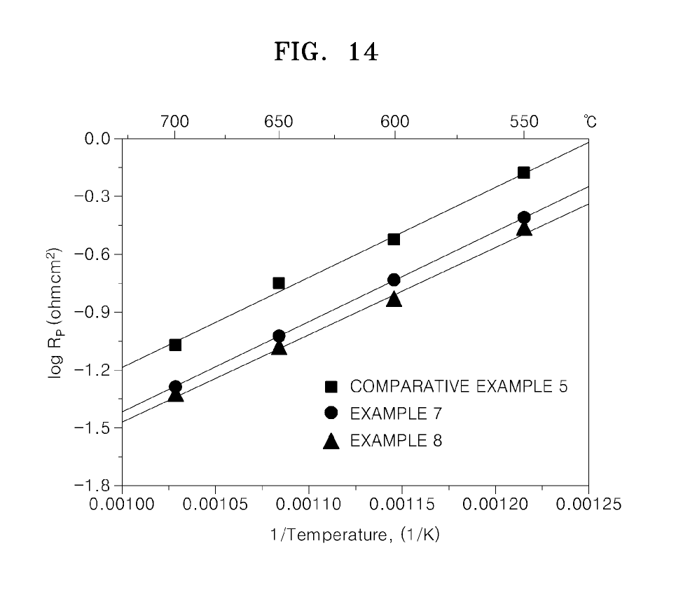

The impedance of the symmetrical cells of Examples 7-8 and Comparative Example 5 were measured at different operating temperatures in an air atmosphere. An Arrhenius plot of the cathode specific resistance (Rₚ) of each symmetrical cell at different operating temperatures is shown in FIG. 14.

Referring to FIG. 14, the cathode specific resistance is found to be lower in the symmetrical cells of Examples 7 and 8 using the mixed cathode material of BSCF and Co₃O₄, or BSCF, Co₃O₄ and SNDC, respectively, as compared with the symmetrical cell of Comparative Example 5 using the cathode material BSCF alone. In particular, the cathode specific resistance (Rₚ) was lowest in the symmetrical cell using the mixed cathode materials BSCF, Co₃O₄ and SNDC, indicating that these materials provided enhanced ionic conductivity.

As described above, according to the one or more of the above embodiments of the present disclosure, a cathode material for a fuel cell may provide lower polarization resistance of the cathode of a solid oxide fuel cell, and thus an electrode resistance of the solid oxide fuel cell may be suitable when operated at a temperature of 800° C. or less. By using the cathode material, a solid oxide fuel cell operable at a low temperature of 800° C. or less may be manufactured.

It should be understood that the exemplary embodiments described herein should be considered in a descriptive sense only and not for purposes of limitation. Descriptions of features, advantages, or aspects within each embodiment should be considered as available for other similar features, advantages, or aspects in other embodiments.

What is claimed is:

1. A cathode material for a fuel cell, the cathode material comprising:
a first metal oxide having a perovskite structure; and
a second metal oxide having a spinel structure.

2. The cathode material of claim 1, wherein the first metal oxide is represented by Formula 1 below:
AMO_{3+δ} Formula 1
wherein A is at least one element selected from a lanthanide element and an alkaline earth metal element;
M is at least one transition metal element; and
δ indicates an excess or deficit of oxygen.

3. The cathode material of claim 2, wherein the first metal oxide is represented by Formula 2 below:
A′₁₋ₓA″ₓM″O_{3±δ} Formula 2
wherein A′ is at least one selected from barium, lanthanum, and samarium;
A″ is different from A′ and A″ is at least one element selected from strontium, calcium, and barium;
M′ is at least one element selected from manganese, iron, cobalt, nickel, copper, titanium, niobium, chromium, and scandium;
0≦x<1; and
δ indicates an excess or deficit of oxygen.

4. The cathode material of claim 1, wherein the first metal oxide comprises at least one selected from barium strontium cobalt iron oxide, lanthanum strontium cobalt oxide, lanthanum strontium cobalt iron oxide, lanthanum strontium chromium manganese oxide, lanthanum strontium manganese oxide, lanthanum strontium iron oxide, and samarium strontium cobalt oxide.

5. The cathode material of claim 1, wherein the second metal oxide is represented by Formula 3 below:
M″₃O₄ Formula 3
wherein M″ is at least one selected from Co, Fe, Mn, V, Ti, Cr, and an alloy thereof.

6. The cathode material of claim 5, wherein the second metal oxide is at least one of Co₃O₄, Fe₃O₄, or Mn₃O₄.

7. The cathode material of claim 1, wherein the second metal oxide has a melting point of from about 800° C. to about 1,800° C.

8. The cathode material of claim 7, wherein the second metal oxide has a melting point of from about 900° C. to about 1,500° C.

9. The cathode material of claim 1, wherein the first metal oxide is contained in an amount of about 60 wt % to about 99 wt %, and the second metal oxide is contained in an amount of about 1 wt % to about 40 wt %, based on a total weight of the first metal oxide and the second metal oxide.

10. The cathode material of claim 9, wherein the first metal oxide is contained in an amount of about 70 wt % to about 95 wt %, and the second metal oxide is contained in an amount of about 5 wt % to about 30 wt %, based on a total weight of the first metal oxide and the second metal oxide.

11. The cathode material of claim 9, wherein the first metal oxide is contained in an amount of about 80 wt % to about 95 wt %, and the second metal oxide is contained in an amount of about 5 wt % to about 20 wt %, based on a total weight of the first metal oxide and the second metal oxide.

12. The cathode material of claim 1, further comprising a third metal oxide having a fluorite structure.

13. The cathode material of claim 12, wherein the third metal oxide comprises cerium and at least one lanthanide element.

14. The cathode material of claim 12, wherein the third metal oxide is represented by Formula 4 below:
Ce_{1-y}M′″_{y}O₂ Formula 4
wherein M′″ is at least one selected from lanthanum, praseodymium, neodymium, promethium, samarium, europium, gadolinium, terbium, dysprosium, and an alloy thereof; and
0 <y<1.

15. The cathode material of claim 14, wherein M′″ comprises Sm and at least one element selected from Pr, Nd, Pm, and an alloy thereof.

16. The cathode material of claim 12, wherein a weight ratio of a combination of the first metal oxide and the second metal oxide to the third metal oxide is about 99:1 to about 60:40.

17. A cathode for a fuel cell comprising the cathode material of claim 1.

18. A solid oxide fuel cell comprising:
a cathode including the cathode material according to claim 1;
an anode disposed opposite to the cathode; and
a solid oxide electrolyte disposed between the cathode and the anode.

19. The solid oxide fuel cell of claim 18, wherein the solid oxide electrolyte comprises at least one selected from a zirconia solid electrolyte, a ceria solid electrolyte, and a lanthanum gallate solid electrolyte.

20. The solid oxide fuel cell of claim 18, further comprising an electric current collector layer on an outer side of the cathode, the electric current collector layer comprising at least one selected from lanthanum cobalt oxide, lanthanum strontium cobalt oxide, lanthanum strontium cobalt iron oxide, lanthanum strontium manganese oxide, and lanthanum strontium iron oxide.

21. The solid oxide fuel cell of claim 18, further comprising a functional layer effective to prevent or suppress a reaction between the cathode and the solid oxide electrolyte, the functional layer comprising at least one of gadolinia-doped ceria, samaria-doped ceria, and yttria-doped ceria.
